(19) United States
(12) Patent Application Publication
(10) Pub. No.: US 2014/0355476 A1
(43) Pub. Date: Dec. 4, 2014

(54) SYSTEMS AND METHODS FOR MESH NETWORK DEPLOYMENT

(71) Applicants: GLEN J. ANDERSON, Beaverton, OR (US); ALBERT YOSHER, Raanana (IL); DAVID I. POISNER, Carmichael, CA (US)

(72) Inventors: GLEN J. ANDERSON, Beaverton, OR (US); ALBERT YOSHER, Raanana (IL); DAVID I. POISNER, Carmichael, CA (US)

(21) Appl. No.: 13/908,162

(22) Filed: Jun. 3, 2013

(51) Int. Cl. H04W 16/18

(52) U.S. Cl. CPC H04W 16/18
USPC 370/254

(57) ABSTRACT

Systems and methods to deploy a mesh network comprising one or more access point (AP) modules and at least one deployment server to a deployment region. The AP module may be configured to determine location and/or status information based on global navigation satellite signals and/or sensor signals and communicate the location and/or status signals to the deployment servers. The deployment servers may be configured to initiate deployment of additional AP modules to the deployment region based at least in part on the received location and/or status information.

### TECHNICAL FIELD

This disclosure generally relates to systems and methods for deployment of mesh networks.

### BACKGROUND

At times of disaster, such as after an earthquake or flood, or in a war zone, physical infrastructure, such as network connectivity may be disabled. Often times, there may be a demand for connectivity during these situations. For example, people in a disaster zone may desire to connect to the Internet or other networks to communicate. Therefore, it may be desirable to deploy network connectivity rapidly in regions that do not currently have it, such as in areas war is ongoing or where a disaster has taken place.

### BRIEF DESCRIPTION OF THE FIGURES

Reference will now be made to the accompanying drawings, which are not necessarily drawn to scale, and wherein:

FIG. 1 is a simplified schematic diagram of an example mesh network deployment including a deployment sever and access point (AP) modules, in accordance with embodiments of the disclosure.

FIG. 2 is a simplified block diagram illustrating an example architecture of the AP modules of the example mesh network of FIG. 1, in accordance with embodiments of the disclosure.

FIG. 3 is a simplified block diagram illustrating an example architecture of the deployment server of the example mesh network of FIG. 1, in accordance with embodiments of the disclosure.

FIG. 4 is a flow diagram illustrating an example method for routing communications via an AP module, in accordance with embodiments of the disclosure.

FIG. 5 is a flow diagram illustrating an example method for detecting a gap and deploying an AP module, in accordance with certain embodiments of the disclosure.

FIG. 6 is a schematic diagram illustrating an example environment where a communications gap is mitigated by deployment of an AP module, in accordance with certain embodiments of the disclosure.

### DETAILED DESCRIPTION OF EMBODIMENTS OF THE INVENTION

Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the invention to those skilled in the art. Like numbers refer to like, but not necessarily the same or identical, elements throughout.

Embodiments of the disclosure may provide systems, apparatus, and methods for deploying a mesh network over a geographic region, such as a predefined geographic region. Such a mesh network may provide connectivity to client and/or user devices within the geographic region to one or more deployment servers that may provide connectivity between the deployed mesh network to one or more other networks, such as the Internet or local area networks (LAN). The mesh network may be deployed by dispersing a plurality of mesh network access point (AP) modules. The AP modules may be preconfigured to cooperate with other AP modules deployed throughout the geographic region over which mesh network coverage is desired. The deployment of the AP modules may be managed and/or organized by the deployment servers. Therefore, in certain embodiments, the deployment servers may provide both connectivity of the deployed mesh network with other and/or larger networks, such as the Internet, and manage the deployment of AP modules within the mesh network. In other embodiments, the connectivity of the deployed mesh network may be provided by an entity separate from the deployment servers, such as one or more network servers.

In certain example embodiments, the AP modules may include a radio, an antenna, a power source, global navigation satellite system (GNSS) receiver (e.g. global positioning satellite (GPS) receiver), and/or one or more sensors. The AP module may be preconfigured, such as with a predetermined and/or preregistered mesh network identifier, such as one or more pre-determined service set identifiers (SSIDs). The AP module may be configured to operate in a mesh network configuration where the AP module may receive incoming data packets, either from a client device communicating with the AP module and/or another AP module and relay those data packets to yet another AP module, deployment server, and/or network server. In other words, the AP module may be configured to transport data packets by receiving the data packets and then retransmitting the data packets. The AP module may further be configured to communicate via any suitable protocol and/or mechanisms, such as Wi-Fi and/or Wi-Fi direct.

The AP module may yet further be configured to self-configure for connecting to the mesh network. In one aspect, upon deployment, the AP module may “listen” for beacons with the identification associated with the AP module, such as the same SSID. In another aspect, when the AP module detects one or more beacons with a network identifier to which the AP module is to connect, the AP module may transmit a beacon to enable other AP modules in its relative proximity to detect its presence. After completing handshaking protocols with other deployed AP modules of the mesh network, the deployed AP module may operate within the mesh network. In one sense, the AP module may operate as a router within the mesh network. In another sense, the deployed AP module along with other AP modules may dynamically and seamlessly reconfigure the mesh network as new AP modules are deployed and added to the mesh network. The mesh network may reconfigure itself to provide a nearest neighbor and/or shortest transit time pathway to transmit information and/or data between AP modules. In certain embodiments, multiple pathways from a single AP module may be set-up by the AP modules of the mesh network. In other embodiment, multiple pathways from a single AP module may be prevented to avoid network loops. After configuration of the mesh network, the constituent AP modules may be able to relay communications, such as in the form of data packets, to its nearest neighbor AP module.

The AP modules may still further be configured to provide a variety of status and/or location information associated with the AP modules. The status and/or location information may be transmitted from one AP module to another, such as in the form of one or more data packets, via the mesh network until the status and/or location information reach the deployment servers. These information may be used by the deployment servers to determine the coverage of the deployed mesh network and/or to control the deployment of further AP modules. The status and/or location information may be collected by the AP modules with one or more sensors and/or GNSS antennas disposed thereon or therein. The location information may be indicative of where the AP module is located. This location information may, in certain embodiments, be processed location coordinates, such as latitude, longitude, and/or altitude coordinates derived from GNSS signals, such as GPS signals. In other embodiments, raw GNSS signals may be provided by the AP module as location information. The status information may be any variety of suitable information that may provide an indication of the functions of the AP module. This status information may include one or more of transmit/receive signal strength, effective transmit/receive bandwidth, power level of the AP module, battery charge level of the AP module, supplementary power generation levels, or the like.

To provide the location information and/or status information, the AP modules may include a GNSS antenna and GNSS processors to determine position of the particular AP module based at least in part on received GNSS signals, such as GPS time and/or pseudo-range signals. The AP modules may also include a variety of sensors, such as accelerometers, ammeters, voltmeters, or the like. To power the AP module in the deployment region, where in some cases, physical power infrastructure may not exist or may be inoperable, the AP module may include one or more power sources, such as batteries and/or solar cells, to provide power for performing the functions, such as network functions, of the AP modules.

The AP modules may be deployed in a manner where a radio and antenna of the AP module may be able to transmit a signal, such as a Wi-Fi signal, a distance such that the transmitted signal may be received by an adjacent AP module. If an adjacent AP module cannot receive the transmitted signal from a particular AP module, then that particular AP module may not be able to relay its signal onto other portions of the mesh network. As a result, there may be gaps in the coverage of the mesh network over the deployment region. When gaps arise, in some cases, the AP module may be unable to report its location and/or status information to one or more deployment servers. In this case, in certain embodiments, the AP module may be configured to increase its transmit power to broadcast a beacon that may be received over a larger spatial range. This relatively longer range beacon may indicate the AP module's location and may provide an indication to other AP modules to increase their transmit powers, at least temporarily, to enable the inclusion of the isolated AP module into the mesh network. In the same or other embodiments, the AP module, when not connected to the mesh network and/or when unable to handshake with the mesh network, may be configured to transmit an out-of-band signal to indicate its position and/or isolation from the mesh network. This out-of-band signal may be, for example, transmitted to a satellite and relayed via satellite communications to the deployment servers to make the deployment servers aware of the location of the isolated AP module. In addition, an isolated AP module may be configured to enter into a security mode when it is isolated. In this security mode, unauthorized individuals may be locked-out from the ability to reconfigure the isolated AP module. For example, an individual, without authentication credentials may be unable to change the network identifier, such as the SSID of the AP module. In the security mode, the AP module may not be an attractive item for individuals to steal.

The AP modules may be originally deployed to or subsequently moved within the mesh network by any variety of mechanisms, such as by human delivery, by air, such as by drones, by water, such as by boats, or by land, such as by autonomous vehicles. In some cases, the AP modules may have protective features to enable deployment and/or prevent damage to the AP module during deployment. These protective features may include waterproofing, deployable parachutes, deployable air bags, or the like. These protective features may enable the AP modules to be deployed by air, water, and/or land. In some cases, the AP modules may be configured to be mobile. For example the AP module may be disposed upon an autonomous and/or remotely controlled vehicle. A mobile AP module may be configured to self-position itself within the mesh network region, such as based at least in part on signals and/or instructions received from the deployment servers. Furthermore, the AP modules may be of a suitable shape and size such that individuals within the deployment region may be able to carry them to points within the deployment region where there may be a relative lack of AP modules.

One or more AP modules, such as on the edges of the deployment region, may be in communications with the deployment servers and/or network servers. It may be through these gateway AP modules that network traffic gets routed from the mesh network to one or more larger networks, such as the Internet, via the deployment servers and/or network servers. Furthermore, one or more gateway AP modules may be coupled to the deployment servers and it may be through these gateway AP modules that status information and/or location information may be communicated from the AP modules of the deployed mesh network to the deployment servers for monitoring and control of the mesh network.

The deployment servers may receive and analyze the received status and/or location information from the AP modules deployed in the deployment region. The deployment servers may also be configured to receive one or more maps of the deployment region. These maps may be of any suitable variety, such as political maps, population maps, and/or topography maps, and may be received from any variety of sources, such as from Internet-based resources. The deployment servers may use the location information received from the deployed AP modules, along with a map of the deployment region, to determine if there are gaps in the coverage of the deployment region. In certain embodiments, the deployment servers may determine gaps in network coverage in the deployment region without a map of the deployment region. In this case, the deployment servers may have an indication of the bounds of the deployment region, such as one or more latitude and longitude data indicating the borders of the deployment region. If there are gaps in the mesh network coverage, then the deployment servers may further be configured to initiate deployment of additional AP modules and/or move already deployed AP modules. The deployment servers may further be configured to receive out-of-band signals from isolated AP modules, such as satellite based communications. In response to those signals, the deployment servers may arrange to move and/or retrieve the isolated AP module and/or deploy additional AP modules to provide connectivity to the isolated AP module.

The deployment servers may further be configured to receive status information from the deployed AP modules and, based at least in part thereon, monitor the operations of the mesh network. The deployment servers may monitor the received status information to detect deficiencies and/or weaknesses within the deployed mesh network and may be configured to proactively mitigate the risks of mesh network failure or failure of constituent communication links. For example, the deployment servers may be able to detect AP modules that may be malfunctioning, operating in a non-optimal manner, or are likely to imminently malfunction based on received status information from that AP module. The deployment servers, in this case, may deploy redundant AP modules to locations where an AP module may be likely to fail and/or run out of battery power.

It will be appreciated that a mesh network may be deployed rapidly and with relatively little human interaction to a predefined deployment region. As a non-limiting example, the deployment region may be a war zone where communications infrastructure may need to be set up. In these cases, various levels of security and/or authentication may be implemented to prevent interception of communications. As another non-limiting example, the deployment region may be a region afflicted by a disaster, such as an earthquake, flood, hurricane, tsunami, terrorist attack, an industrial accident, or the like, with resulting damage to communications and/or power distribution infrastructure. It will be appreciated that the deployed mesh network may be utilized by those individuals afflicted by the disaster in communicating, such as with loved ones and/or emergency personnel, or by emergency personnel, government officials, or those involved in disaster recovery.

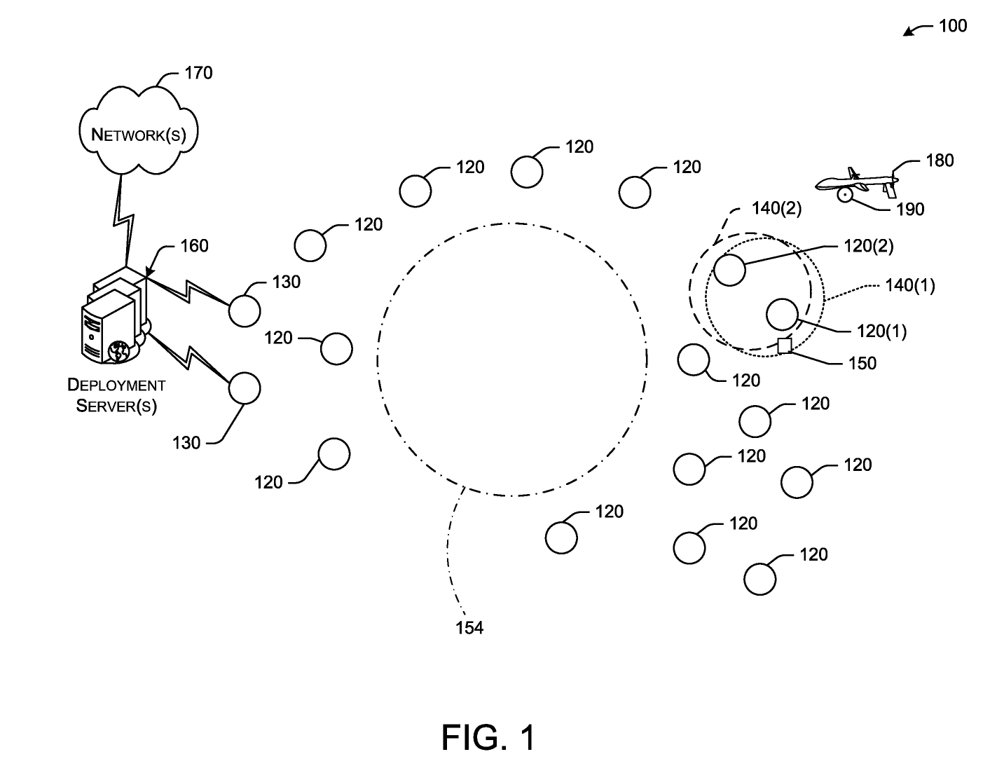

FIG. 1 is a simplified schematic diagram of an example mesh network deployment 100 including a deployment sever 160 and access point (AP) modules 120, in accordance with example embodiments of the disclosure. The deployment 100 may include the one or more access point (AP) modules 120(1), 120(2), 120, 130 dispersed over the deployment region 110. Each AP module 120, 130 may have a range 140(1) and 140(2), as indicated for AP modules 120(1) and 120(2), respectively. AP modules 130 may be communicatively coupled to one or more deployment servers 160 and at least one other AP module 120. The deployment servers 160 may further be communicatively coupled to one or more networks 170, such as the Internet, local area networks (LANs), wide area networks (WANs), or the like. The deployment 100 may further include one or more client devices 150 configured to communicate with one or more of the AP modules 120(1).

The networks 170 may include any one or a combination of different types of suitable communications networks, such as cable networks, the Internet, wireless networks, cellular networks, and other private and/or public networks. Furthermore the networks 170 may include any variety of medium over which network traffic is carried including, but not limited to, coaxial cable, twisted wire pair, optical fiber, hybrid fiber coaxial (HFC), microwave terrestrial transceivers, radio frequency communications, satellite communications, or combinations thereof. It is also noted that the described techniques may apply in other client/server arrangements (e.g., set-top boxes, etc.), as well as in non-client/server arrangements (e.g., locally stored software applications, etc.).

The client device 150, as used herein, may be one of any variety of client devices, electronic devices, communications devices, and/or mobile devices. The client device 150 may include, but is not limited to, tablet computing devices, electronic book (ebook) readers, netbook computers, notebook computers, laptop computers, desktop computers, personal digital assistants (PDA), smart phones, web-enabled televisions, video game consoles, set top boxes (STB), or the like.

Generally, a particular AP module 120(1), 120(2) may be able to communicate with another AP module 120(1), 120(2), if its range 140(1), 140(2) extends to or beyond the other AP module 120(1), 120(2). As depicted, the AP modules 120(1), 120(2) may be able to communicate with each other, as their respective ranges 140(1), 140(2) overlap with the other AP module 120(2), 120(1), respectively. Additionally, the AP module 120(1) may be able to communicate with the client device 150 since the client device 150 is within the range 140(1) of the AP module 120(1). The AP module range (hereinafter referred to as range 140) may be the distance from the AP module 120, where the transmit signal power is great enough that another AP module 120 may detect and/or receive the signal and identify data carried thereon with suitable reliability. In other words, the range 140 may be a distance where the transmitted signal strength of the corresponding AP module 120 is greater than a predetermined threshold level, wherein the threshold level may, in some cases, be configurable and related to transmission reliability of the AP module 120. The deployed AP modules (hereinafter referred to individually or collectively as AP module(s) 120) may, therefore, be positioned in a manner in the mesh network deployment 100 such that each AP module 120 may be able to communicate with at least one nearest neighbor AP module 120. In some cases, especially during the process of mesh network deployment, a coverage gap 154 may develop within the deployment region 110. The gap may represent a region within the deployment region 110 where there is no mesh network coverage. In other words, a client device 150 located within the gap 154 may not be able to interact with the mesh network deployment 100.

The AP modules 120 may communicate with each other and/or client devices 150 using any suitable communication formats and/or protocols including, but not limited to, Wi-Fi, direct Wi-Fi, Bluetooth, 3G mobile communication, 4G mobile communication, long-term evolution (LTE), WiMax, direct satellite communications, or combinations thereof. The AP modules 120 may communicate with each other to receive and then retransmit information, such as data packets. By doing so, the AP modules 120 may serve as a router-to-route communications from points within the deployment region 110 to the deployment servers 160, via the AP modules 130. Therefore, a particular AP module 120 may be configured to communicate with another AP module 120, such as a nearest neighbor AP module 120 to relay information along a path defined by one or more AP modules 120 of the deployment 100. The concepts of point-to-point communications and mesh networks along with the configurations of each are well known in the art and, in the interest of brevity, will not be discussed further.

AP modules 130 may communicate with other AP modules 120 via any suitable wireless mechanism, such as the aforementioned formats and/or protocols. The AP modules 130 may further communicate with the deployment servers 160 via any suitable wireless and/or wired formats and/or protocols, including the aforementioned wireless formats and/or protocols. The AP modules 130 may serve as gateways for communication between clients 150 and other AP modules 120 with the deployment servers 160. In certain example embodiments, there may be a plurality of AP modules 130 in communication with the deployment servers 160 so that no one AP module 130 bottlenecks the communications between the mesh network and the deployment servers 160.

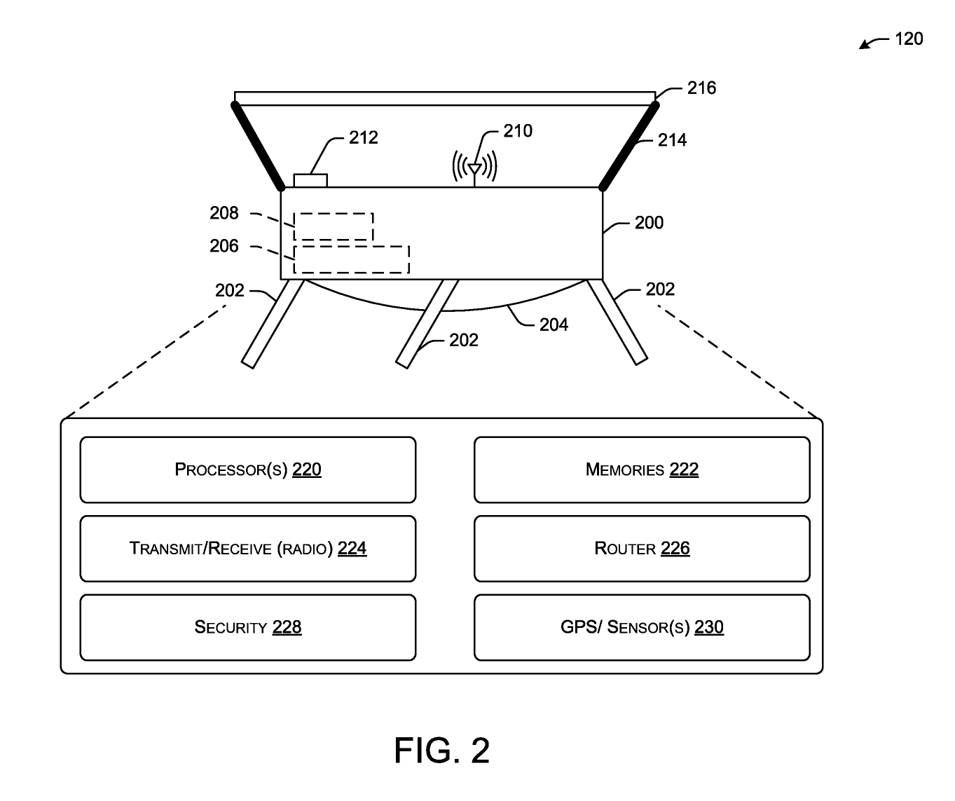

Each of the AP modules 120 may be configured to collect status and/or location information about itself. The status and/or location information may be collected by the AP modules 120 with one or more sensors and/or GNSS antennas disposed thereon or therein, as will be described further in reference to FIG. 2. The location information may be indicative of where the AP module 120 is located, such as within the deployment region 110. This information may, in certain example embodiments, be processed location coordinates, such as latitude, longitude, and/or altitude coordinates derived from GNSS signals, such as GPS signals. In other example embodiments, raw GNSS signals may be provided by the AP module 120 as location information. The status information may be any variety of suitable information that may provide an indication of the functioning of the AP module 120. This information may include one or more of transmit/receive signal strength, effective transmit/receive bandwidth, power level of the AP module, battery charge level of the AP module, supplementary power generation levels, or the like.

The deployment servers 160 may be configured to receive and/or analyze the received status and/or location information from the AP modules 120 deployed in the deployment region 110. The status and/or location information may be received in the form of one or more data packets via one or more gateway AP modules 130. The deployment server 160 may utilize one or more rules, protocols, and/or algorithms to analyze the received status and/or location information to identify parameters associated with the mesh network deployment 100.

The deployment servers 160 may also be configured to receive one or more maps of the deployment region. These maps may be of any suitable variety, such as political maps and/or topography maps, and may be received from any variety of sources, such as from Internet-based resources via the networks 170. The deployment servers 160 may use the location information received from the deployed AP modules 120, along with a map of the deployment region, to determine if there are gaps 154 in the mesh network coverage of the deployment region 110. If there are gaps 154 in the mesh network coverage, then the deployment servers 160 may further be configured to instantiate deployment of additional AP modules 120 and/or move already deployed AP modules 120. The deployment servers 160 may further be configured to receive out-of-band signals from isolated AP modules 120, such as satellite based communications. Responsive to those signals, the deployment servers 160 may arrange to move and/or retrieve the isolated AP module 120 and/or deploy additional AP modules 120 to provide connectivity to the isolated AP module 120.

The deployment server 160 may instruct and/or direct the deployment and/or movement of AP modules 120 to “fill” gaps 154 in the mesh network deployment 100, by directing the deployment of a vehicle 180, such as an aerial drone 180, to deliver a new AP module 190, as depicted. In certain embodiments, the vehicle 180 may position itself, with the new AP module 190, within the gap 154 to provide additional mesh network coverage. In other embodiments, the vehicle 180 may deliver the new AP modules 190 within the gap 154 to provide additional coverage of the mesh network. Some non-limiting examples of delivery may include air-dropping the AP module 190 from an aircraft, dropping the AP modules from a land-based vehicle, and/or throwing the AP module overboard from a water-based vehicle. While the vehicle is depicted herein as an aerial drone 180, it will be appreciated that the vehicle, in other example embodiments of the disclosure, may include, but is not limited to, a rover, an autonomous vehicle, a car, a truck, a light-duty truck, a heavy-duty truck, a pickup truck, a minivan, a crossover vehicle, a van, a commercial vehicle, a private vehicle, a sports-utility vehicle, a tractor-trailer, an aircraft, an airplane, a jet, a helicopter, an aerial drone, a space vehicle, a watercraft, a boat, a ship, an autonomous water vehicle, a remote-controlled water vehicle, a buoy, or any other suitable vehicle. In certain embodiments, the deployment servers 160 may be in direct communication with the deployment vehicle 180. In other embodiments, the deployment servers 160 may be configured to direct the delivery of the AP module 190 by communicating with an intermediary element that may control the launch and/or movement of the deployment vehicle 180.

FIG. 2 is a simplified block diagram illustrating an example architecture of the AP modules 120 of the example mesh network deployment 100 of FIG. 1, in accordance with example embodiments of the disclosure. The AP module 120 may include a body region 200 housing the internal components of the AP module 120, base and/or stand elements 202, a weight 204 to plant the AP module in an advantageous and/or operational orientation, and one or more antennas. Example antennas include, but are not limited to, a communications antenna 210 and a GNSS antenna 212. The AP module 120 may further include one or more brackets 214, one or more power sources, such as a battery 206 and a solar cell 216, and one or more control modules 208. In one example embodiment, the control module 208 may include one or more processors 220, one or more memories 222, a radio component 224, a router component 226, a security component 228, and a GPS/sensor component 230.

The body region 200, the stand 202, the weight 204, and the brackets 214 may be constructed from any suitable materials including, but not limited to, polymers, metals, ceramics, composites, or the like. Additionally, the body region 200, the stand 202, the weight 204, and the brackets 214 may be fabricated by any suitable process including molding, extrusion, machining, rolling, three-dimensional printing, any combination thereof, or the like.

The battery 206 may be any suitable type of battery including, but not limited to, wet cells, dry cells, lead-acid, lithium, lithium hydride, lithium ion, or the like, at any suitable voltage and/or output current. In certain embodiments, the battery 206 may be rechargeable and may be recharged by one or more other power sources, such as the solar cell 216. The solar cell 216 may be any suitable photovoltaic module constructed by any suitable material and process. Some non-limiting example solar cells 216 may include polycrystalline silicon, crystalline silicon, III-V semiconductor, thin film, quantum dots, or the like.

The communications antenna 210 may be any suitable type of antenna corresponding to the communications protocols used by the AP module 120. Some non-limiting examples of suitable communications antennas 210 include Wi-Fi antennas, IEEE 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to the radio component 224 to transmit and/or receive signals, such as communications signals to and/or from other AP modules 120.

The GNSS antenna 212 may be any suitable type of GNSS antenna to receive GNSS signals, such as GPS time and/or pseudo-range signals. The GNSS may be any one of known current GNSS or planned GNSS, such as the Global Positioning System (GPS), the GLONASS System, the Compass Navigation System, the Galileo System, or the Indian Regional Navigational System. The GNSS may include a plurality of satellites broadcasting radio frequency (RF) signals including satellite transmission time and position information. The satellite RF signals received from three or more satellites via the GNSS antenna 212 may be used by the AP modules 120, and the GPS/sensor component 230, in particular, to obtain navigation data using known GNSS or GPS signal and data processing techniques.

The processors 220 of the AP module 120 may be implemented as appropriate in hardware, software, firmware, or combinations thereof. Software or firmware implementations of the processors 220 may include computer-executable or machine-executable instructions written in any suitable programming language to perform the various functions described. Hardware implementations of the processors 220 may be configured to execute computer-executable or machine-executable instructions to perform the various functions described. The one or more processors 220 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The AP module 120 may also include a chipset (not shown) for controlling communications between one or more processors 220 and one or more of the other components of the AP module 120. The processors 220 may also include one or more application specific integrated circuits (ASICs) or application specific standard products (ASSPs) for handling specific data processing functions or tasks. In certain embodiments, the AP module 120 may be based on an Intel® Architecture system and the one or more processors 220 and chipset may be from a family of Intel® processors and chipsets, such as the Intel® Atom® processor family.

The memory 222 may include one or more volatile and/or non-volatile memory devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The memory 222 may store program instructions that are loadable and executable on the processor(s) 220, as well as data generated or received during the execution of these programs. The memory 222 may have stored thereon software modules and/or instructions associated with components 224, 226, 228, and/or 230. The memory 222 may include one or more operating systems (O/S) application software. Each of the modules and/or software stored on the memory 222 may provide functionality for the AP module 120, when executed by the processors 220.

The transmit/receive or radio component 224 may include any suitable radio for transmitting and/or receiving radio frequency (RF) signals in the bandwidth and/or channels corresponding to the communications protocols utilized by the AP module 120 to communicate with other AP modules 120 and/or client devices 150. The radio component 224 may include hardware and/or software to modulate communications signals according to pre-established transmission protocols. The radio component 224 may further have hardware and/or software instructions to communicate via one or more Wi-Fi and/or Wi-Fi direct protocols, as standardized by the Institute of Electrical and Electronics Engineers (IEEE) 802.11 standards. In certain embodiments, the radio component 224, in cooperation with the communications antennas 210, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In alternative embodiments, non-Wi-Fi protocols may be used for communications between adjacent AP modules 120, such as Bluetooth, dedicated short-range communication (DSRC), or other packetized radio communications. The radio component 224 may include any known receiver and baseband suitable for communicating via the communications protocols of AP module 120. The radio component may further include a low noise amplifier (LNA), additional signal amplifiers, an analog-to-digital (A/D) converter, one or more buffers, and digital baseband.

The router component 226 may include a variety of hardware and/or software to operate the AP modules 120 as a router within the mesh network. The router component 226 may enable the AP module to transmit and/or receive communications beacons to identify other AP modules in its relative proximity. The router component 226 may also include instructions that, when executed by the processors 220, enable the AP module 120 cooperate with other AP modules 120 to identify a pathway to another AP module 120 for routing mesh network traffic. In certain embodiments, a fastest pathway may be identified and established by the processors 220 in cooperation with the router component 226. The establishment of the fastest pathway may involve transmitting and/or receiving handshaking signals form AP modules 120 within radio range. In certain embodiments, the router component 226 may include logic to prevent multiple pathways for communication from the AP module 120 to a root and/or deployment server 160, to prevent network loops and/or broadcast storms. The router component 226 may further enable the AP module 120 to dynamically reconfigure communication pathways based at least in part on the deployment of new AP modules 120 within the mesh network.

The security component 228 may have instructions stored thereon that may enhance the security of AP modules 120 that are openly deployed throughout a deployment region 100. In particular, the security component 228 may include hardware and/or software-based algorithms that may be executed in cooperation with the processors 220 to reduce the possibility of theft of an isolated AP module 120. In particular, the AP module 120 may be configured to identify that it is isolated from other AP modules 120 of the mesh network. At this point, the AP module 120 may be configured to continue “listening” for AP module beacons while locking out any other functionality of the AP module 120. Therefore, the AP module 120 may passively “listen” for other beacons and during that time may otherwise be effectively non-functional. In this security mode, a full range of functionality of the AP module 120 may be turned on only when an appropriate network beacon is detected by the AP module 120, such as an SSID with which the AP module 120 is preconfigured. In certain example embodiments, the security component 228 may provide functionality that prevents the AP module 120 from being reconfigured with a new network identifier, such as an SSID, without providing authentication credentials, such as a login and/or password. In other words, the security component 228 may enable the “lockout” of key AP module functionality if the AP module 120 is isolated. Therefore, the AP module 120, as a result of the functionality enabled by the security component 228 may have minimal functional use or monetary value if stolen.

The GPS/sensor component 230 may include sensors as well as hardware and/or software to interpret and/or communicate sensor and/or GNSS information. The sensors may be any variety of suitable sensors, such as accelerometers, ammeters, voltmeters, or the like. The sensors may provide a variety of status information associated with the AP module 120, such as the parameters of the power devices 206, 216, parameters of communication infrastructure 210, 224, 226, indications of isolation, and/or overall functionality of the AP module 120. Some non-limiting examples of status information may include, charge remaining on the battery 206, power levels generated by the solar cell 216, transmit power from the communications antenna 210, communications bandwidth via the radio component 224, and/or time since a beacon and/or communication was received. The GPS/sensor component 230 may further include instructions that enable the processors 220 to interpret a variety of GNSS signals and/or information, such as time and/or pseudo-range information to determine position coordinates of the AP module 120. The processors 220 may further be configured to periodically or on-demand communicate the status and/or location information of the AP module 120 to the deployment servers 160. The information transmitted by the AP module 120 and the processors 220 thereon may have an identifier of the transmitting AP module 120 associated therewith. For example, the status and/or location identifier may be transmitted as a data packet that includes a field that identifies the transmitting AP module 120 as well as the information transmitted.

It will be appreciated that there may be overlap in the functionality of the instructions stored in the radio component 224, the router component 226, the security component 228, and/or the GPS/sensor component 230. In fact, the functions of the aforementioned components 224, 226, 228, 230 may interact and cooperate seamlessly under the framework of the AP module 120. Indeed, each of the functions described for any of the components 224, 226, 228, 230 may be stored, implemented, and/or intermingled within any component 224, 226, 228, 230 in accordance with certain embodiments of the disclosure. Further, in certain embodiments, there may be one single component that includes the instructions, programs, and/or applications described within the radio component 224, the router component 226, the security component 228, and/or the GPS/sensor component 230.

It will be appreciated that in some cases, the AP modules 120 may be configured to move, such as autonomously. For example, the AP module 120 may be disposed on a vehicle 180 or may have the ability for self-mobility. In these cases, the AP module may be configured to move within the deployment region 110. For example, a particular AP module 120 may be configured to move within the deployment region 110 based at least in part on a signal strength associated with the received beacon. The AP module 120 may move, such as in a self-directed fashion to improve communications signal strength with other AP modules 120 within the deployment region with which it communicates. In some cases, the AP module 120 may be able to move based on sensor signals, such as an image sensor disposed thereon. For example, the AP module 120 may be configured to identify topography and may move to a higher elevation to attempt to improve RF signal strength between other AP modules 120 with which it communicates.

It will further be appreciated that in some cases, data may be communicated between AP modules 120 across the gap 154 by a batch mechanism. For example, an AP module 120 and/or deployment vehicle 180 may have one or more storage devices, such as hard disc drives, flash drives, tape drives, or the like. The mobile AP module and/or vehicle 180 may be configured to store data received from a particular AP modules 120 on the one or more storage devices and transport the data to another AP modules 120, such as across the gap 154.

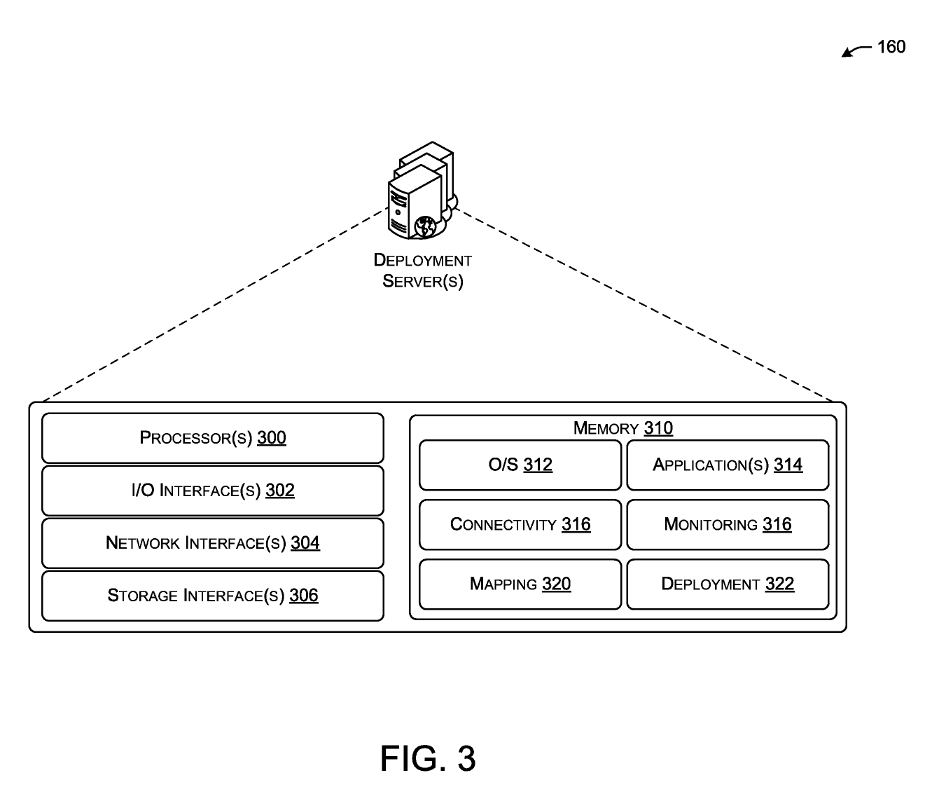

FIG. 3 is a simplified block diagram illustrating an example architecture of the deployment server 160 of the example mesh network deployment 100 of FIG. 1, in accordance with example embodiments of the disclosure. The deployment servers 160, in accordance with embodiments of the disclosure, may include one of more processors 300, I/O interface(s) 302, network interface(s) 304, storage interface(s) 306, and memory 310.

In some examples, the processors 300 of the deployment servers 160 may be implemented as appropriate in hardware, software, firmware, or combinations thereof. Software or firmware implementations of the processors 300 may include computer-executable or machine-executable instructions written in any suitable programming language to perform the various functions described. Hardware implementations of the processors 300 may be configured to execute computer-executable or machine-executable instructions to perform the various functions described. The one or more processors 300 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The deployment servers 160 may also include a chipset (not shown) for controlling communications between the one or more processors 300 and one or more of the other components of the deployment servers 160. The one or more processors 300 may also include one or more application specific integrated circuits (ASICs) or application specific standard products (ASSPs) for handling specific data processing functions or tasks. In certain embodiments, the deployment servers 160 may be based on an Intel® Architecture system and the one or more processors 300 and chipset may be from a family of Intel® processors and chipsets, such as the Intel® Atom® processor family.

The one or more I/O device interfaces 302 may enable the use of one or more (I/O) device(s) or user interface(s), such as a keyboard and/or mouse. A user may be able to administer the deployment of the mesh network by interacting with the deployment servers 160 via the I/O device interfaces 302. The network interfaces(s) 304 may allow the deployment servers 160 to communicate via the one or more network(s) 170 and/or via other suitable communicative channels. For example, the deployment servers 160 may be configured to communicate with stored databases, other computing devices or servers, user terminals, or other devices on the networks 170. The storage interface(s) 306 may enable the deployment servers 160 to store information, such as status and/or location information or deployment information in storage devices.

The memory 310 may include one or more volatile and/or non-volatile memory devices including, but not limited to, magnetic storage devices, read-only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof.

The memory 310 may store program instructions that are loadable and executable on the processor(s) 300, as well as data generated or received during the execution of these programs. Turning to the contents of the memory 310 in more detail, the memory 310 may include one or more operating systems (O/S) 312, an applications module 314, a connectivity module 316, a monitoring module 318, a mapping module 320, and/or a deployment module 322. Each of the modules and/or software may provide functionality for the deployment servers 160, when executed by the processors 300. The modules and/or the software may or may not correspond to physical locations and/or addresses in memory 310. In other words, the contents of each of the modules 312, 314, 316, 318, 320, 322 may not be segregated from each other and may, in fact be stored in at least partially interleaved positions on the memory 310.

The O/S module 312 may have one or more operating systems stored thereon. The processors 300 may be configured to access and execute one or more operating systems stored in the (O/S) module 312 to operate the system functions of the electronic device. System functions, as managed by the operating system may include memory management, processor resource management, driver management, application software management, system configuration, and the like. The operating system may be any variety of suitable operating systems including, but not limited to, Google® Android®, Microsoft® Windows®, Microsoft® Windows® Server®, Linux, Apple® OS-X®, or the like.

The application(s) module 314 may contain instructions and/or applications thereon that may be executed by the processors 300 to provide one or more functionality associated with the deployment and/or the use of the mesh network. These instructions and/or applications may, in certain aspects, interact with the (O/S) module 312 and/or other modules of the deployment servers 160. The applications module 314 may have instructions, software, and/or code stored thereon that may be launched and/or executed by the processors 300 to execute one or more applications and functionality associated therewith. These applications may include, but are not limited to, functionality such as web browsing, business, communications, graphics, word processing, publishing, spreadsheets, databases, gaming, education, entertainment, media, project planning, engineering, drawing, or combinations thereof.

The connectivity module 316 may have instructions stored thereon that, when executed by the processors 300, enable the deployment servers 160 to provide a variety of communications functionality. In one aspect, the processors 300 may be configured to connect and communicate with gateway AP modules 130 via a variety of wireless and/or wireline communications mechanisms and/or protocols. In another aspect, the processors 300 may be configured to connect and communicate with the networks 170. In yet a further aspect, the processors 300 may be configured to relay communications, such as in the form of one or more data packets from the deployed mesh network to the one or more networks 170. This process may involve rerouting traffic incoming from either or both of the mesh network and/or the one or more networks 170.

The monitoring module 318 may have instructions stored therein that may be executed by the processors 300 to receive and analyze various aspects of the status and/or location information from the AP modules 120. The incoming information may have an identifier of a particular AP module 120 associated therewith by which the processors 300 may identify and map the particular received status and/or location information with particular AP modules 120. Some non-limiting examples of received status information may include, charge remaining on the battery 206, power levels generated by the solar cell 216, transmit power from the communications antenna 210, communications bandwidth via the radio component 224, and/or time since a beacon and/or communication was received. This information may be used by the processors 300, by executing instructions stored in the monitoring module 318, to predict potential weaknesses of AP modules 120 of the mesh network deployment 100. For example, from battery charge levels and usage levels of a particular AP module 120, the deployment servers 160 may be able to predict the likelihood of that AP module 120 failing due to running out of battery power.

The mapping module 320 may have instructions stored therein that may be executed by the processors 300 to perform various functions related to analyzing the mesh network coverage of the deployment region 110. The processors 300 may be configured to receive and/or retrieve one or more maps of the deployment region 110 where the mesh network is deployed. These maps may be any suitable type of map including, but not limited to, physical maps, political maps, road maps, resource maps, climate maps, topographic maps, population maps, or combinations thereof. The processors may receive the coverage region maps from any suitable location, including, for example, from the networks 170 and resources connected thereto. Based on the location information received from each of the active AP modules 120 deployed in the deployment region and the map of the deployment region, the deployment severs 160 may be configured to generate a mesh network coverage map which identifies the location of each of the AP modules 120 within the map of the deployment region 110. The mesh network coverage map may further display the radio ranges 140 of each of the AP modules 120 deployed in the deployment region 110. The processors 300 may further be configured to display this coverage map to a user, such as a deployment administrator, on a display device, such as a display monitor. The processors 300 may also be configured to transmit the coverage map, such as via the networks 170, or serve the coverage map to a remote device via the networks 170, thereby enabling deployment administration from a location remote from the deployment servers 160. The deployment servers 160, and the processors 300 thereon, may be further configured, based at least in part on received maps and location information from the deployed AP modules 120, to determine if any gaps 154 exist in the mesh network coverage of the deployment region 110. Furthermore, the processors 300 may be configured to determine the size and/or area of the coverage gaps 154 that may be identified in the deployment region 110. It should be noted that in certain example embodiments, the processors 300 may be able to identify gaps 154 without the use of maps.

The deployment module 322 may have instructions stored thereon that may be executed by the processors 300 to perform a variety of functions related to deploying AP modules 120 within the deployment region 110. The processes enabled by the deployment module 322 may cooperate with the processes enabled by the monitoring module 318 and/or mapping module 320. The processors 300 may be configured to identify gaps 154 and/or predicted failure nodes of the mesh network deployment 100 and initiate the deployment of additional AP module(s) 120 to the gaps 154 and/or points where currently deployed AP modules 120 may fail imminently. In some non-limiting cases, the failure may be predicted to occur within approximately 10 minutes to 1 day. In other non-limiting cases, the failure may be predicted to occur within approximately 1 hour to 4 hours. In some cases, the processors 300 may be configured to communicate directly with deployment vehicles 180 to deploy additional AP modules 190. In other cases, the processors 300 may communicate with an intermediary element, such as a remote sever that may control the use and schedule the sorties of deployment vehicles 180. In the same or other cases, the deployment servers 160 may, individually or in cooperation with other entities, be configured to generate a queue of AP modules 190 to be delivered. This queue may be generated, in certain example embodiments, based on the priority of deployment. For example, the deployment servers 160 may place a relatively higher priority in filling coverage gaps 154 in locations that may have a relatively high population density compared to other locations where gaps 154 may be identified. In some cases, a higher priority may be assigned to filling coverage gaps 154 that replacing AP modules 120 that may be about to fail.

It will be appreciated that there may be overlap in the functionality of the instructions stored in the operating systems (O/S) module 312, the applications module 314, the connectivity module 316, the monitoring module 318, the mapping module 320, and/or the deployment module 322. In fact, the functions of the aforementioned modules 312, 314, 316, 318, 320, 322 may interact and cooperate seamlessly under the framework of the deployment servers 160. Indeed, each of the functions described for any of the modules 312, 314, 316, 318, 320, 322 may be stored in any module 312, 314, 316, 318, 320, 322 in accordance with certain embodiments of the disclosure. Further, in certain embodiments, there may be one single module that includes the instructions, programs, and/or applications described within the operating systems (O/S) module 312, the applications module 314, the connectivity module 316, the monitoring module 318, the mapping module 320, and/or the deployment module 322.

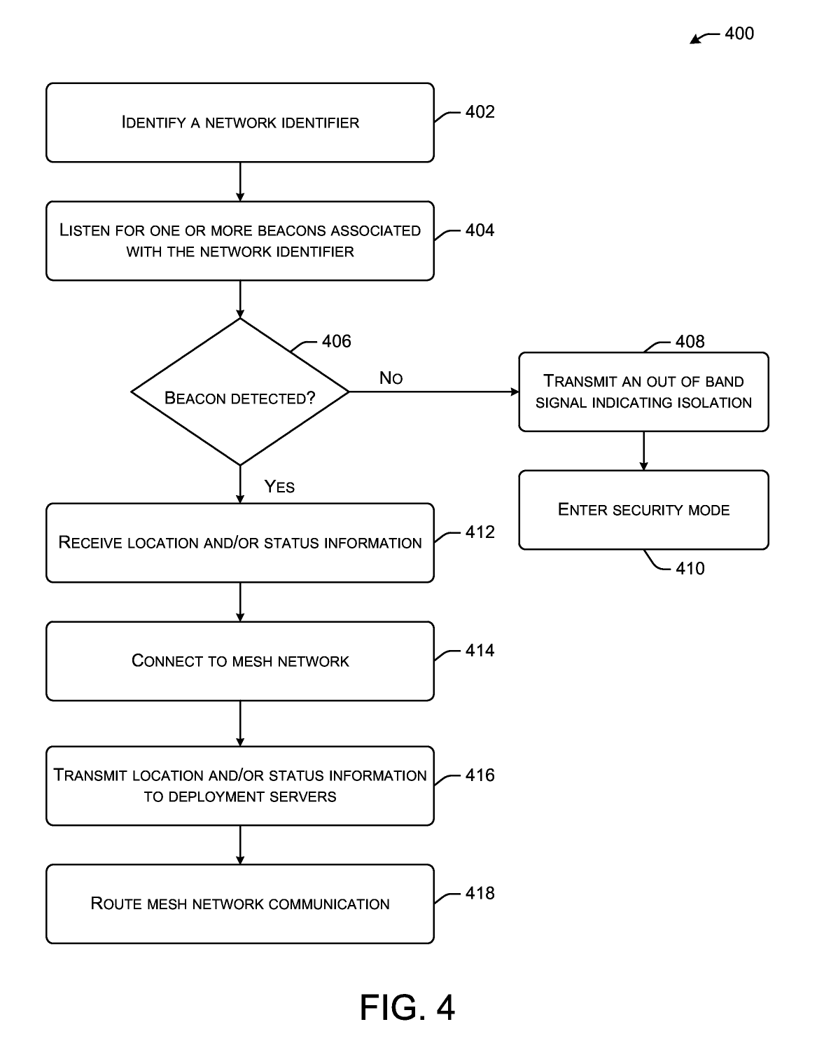

FIG. 4 is a flow diagram illustrating an example method 400 for routing communications via an AP module 120, in accordance with example embodiments of the disclosure. Method 400 may be performed by the AP module 120 in cooperation with one or more other elements of the mesh network deployment 100. At block 402, a network identification may be identified. This network identification may be preconfigured on the AP module 120 and the processors 220 thereon. In certain embodiments, the network identification may be a service set identification (SSID). In these or other embodiments, the AP module 120 may be preconfigured with the network identification by authorized personnel. In some cases, authentication may be needed to assign a network identification to the AP module 120.

At block 404, the AP module 120 may listen for one or more beacons associated with the identified network identification. The AP module 120 may detect one or more beacons, such as beacons from different networks. The beacons may include one or more data packets and may include at least on field with a network identifier. This beacon may be transmitted, such as periodically transmitted, by one or more AP modules 120 in radio range 140 of the deployed AP module 120, to announce that those AP modules 120 are present and operational.

At block 406, it may be determined if a beacon with the identified network identification has been detected. This may be determined by the AP module 120, and the processors 220 thereon, by comparing its preconfigured network identifier with the network identification of the beacon signal detected at block 404. If at block 406 it is determined that the beacon with the network identification has not been detected, then at block 408, the AP module 120 may optionally transmit an out-of-band signal indicating isolation of the AP module 120. This out-of-band signal may be via one or more protocols other than the protocols used to communicate between AP modules 120 and/or with the client device 150. For example, the out-of-band signal may be a communication directly with a satellite may be relay the indication of isolation and/or the location of the isolated AP module 120 to the deployment servers 160. After transmitting the out-of-band signal indicating isolation, the AP module 120 may enter a security mode. The security mode may be a state of the AP module 120 that may deter theft of the isolated AP module 120. In this security mode, the AP module 120 may continue to listen for network beacons, such as beacons that carry a network identifier with which the AP module 120 is preconfigured. In the security mode, the AP module 120 may substantially shut down functions other than listening for beacons.

If at block 406 it is determined that a beacon with the network identifier has been detected, then at block 412, location and/or status information may be received. The location and/or status information may be received from the GPS/Sensor component 230. The location information may be indicative of where the AP module 120 is located, such as within the deployment region 110. This information may, in certain example embodiments, be processed location coordinates, such as latitude, longitude, and/or altitude coordinates derived from GNSS signals, such as GPS signals. In other example embodiments, raw GNSS signals may be provided by the AP module 120 as location information. The status information may be any variety of suitable information that may provide an indication of the functioning of the AP module 120. This information may include one or more of transmit/receive signal strength, effective transmit/receive bandwidth, power level of the AP module, battery charge level of the AP module, supplementary power generation levels, or the like.

At block 414, the AP module 120 may connect to the mesh network. This connection may entail responding to the received beacon and performing a handshaking procedure. This procedure may identify to which other AP modules 120 mesh network traffic is to be received and transmitted. Therefore, this process may determine nearest neighbor and/or shortest time to the deployment servers 160 and/or other network servers. At block 416, the location and/or status information may be transmitted to the deployment servers 160 via the mesh network. The transmission may be via any one of, direct Wi-Fi, Bluetooth, Wi-Fi, dedicated short-range communication (DSRC), or the like.

At block 418, the AP module may route communications and network traffic of the deployed mesh network. The AP modules 120 may communicate with each other and/or client devices 150 using any suitable communication formats and/or protocols. The AP modules 120 may communicate with each other to receive and then retransmit information, such as data packets. By doing so, the AP module 120 may serve as a node within the deployment region 110. Therefore, the AP module 120 may be configured to communicate with another AP module 120, such as a nearest neighbor AP module 120 to relay information along a path defined by one or more AP modules 120 of the deployment 100.

It should be noted, that the method 400 may be modified in various ways in accordance with certain embodiments of the disclosure. For example, one or more operations of method 400 may be eliminated or executed out of order in other embodiments of the disclosure. Additionally, other operations may be added to method 400 in accordance with other embodiments of the disclosure.

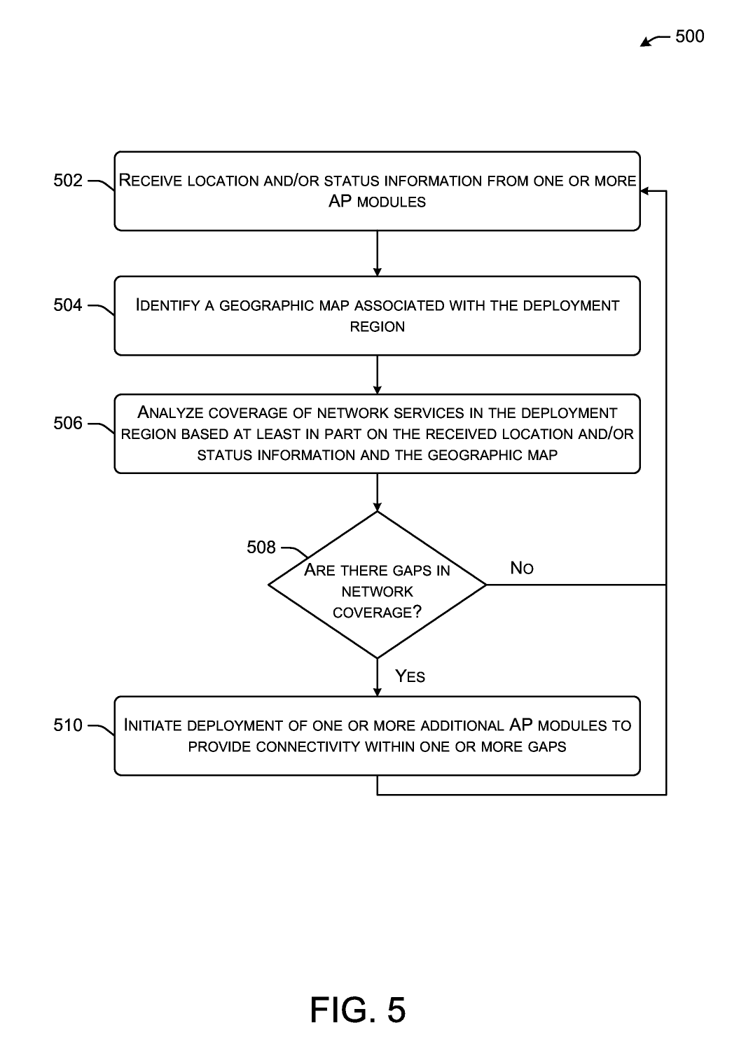

FIG. 5 is a flow diagram illustrating an example method 500 for detecting a gap and deploying an AP module 120, in accordance with certain example embodiments of the disclosure. The method 500 may be executed by the deployment servers 160 and the processors 300 thereon in cooperation with other entities of the mesh network deployment 100. At block 502, location and/or status information may be received from one or more AP modules. These AP modules 120 may be those that are deployed in the deployment region 110. The location information may be indicative of where each of the AP modules 120 are located, such as within the deployment region 110. This information may, in certain example embodiments, be in the form of location coordinates, such as latitude, longitude, and/or altitude coordinates. The status information may be any variety of suitable information that may provide an indication of the functioning of each of the AP modules 120. This information may include one or more of transmit/receive signal strength, effective transmit/receive bandwidth, power level of the AP modules, battery charge level of the AP modules, supplementary power generation levels, or the like.

At block 504, optionally, a geographic map associated with the deployment region may be identified. The deployment servers 160 may receive and/or retrieve one or more maps of the deployment region 110 where the mesh network is deployed. These maps may be any suitable type of map including, but not limited to, physical maps, political maps, road maps, resource maps, climate maps, topographic maps, population maps, or combinations thereof. The deployment servers 160 may receive the coverage region maps from any suitable location, including, for example, from the networks 170 and resources connected thereto.

At block 506, the coverage of the network may be analyzed based at least in part on the received location and/or status information and the geographic maps. The analysis may involve the deployment severs 160 generating a mesh network coverage map which identifies the location of each of the AP modules 120 within the deployment region 110. The mesh network coverage map may further display the radio ranges 140 of each of the AP modules 120 deployed in the deployment region 110. The deployment severs 160 may display this coverage map to a user, such as a deployment administrator, on a display device, such as a display monitor. The deployment severs 160 may also transmit the coverage map, such as via the networks 170, or serve the coverage map to a remote device via the networks 170, thereby enabling deployment administration from a location remote from the deployment servers 160.

At block 508, it may be determined if any gaps exist in the network coverage of the deployment region. Based, at least in part, on the location information received from each of the active AP modules 120 deployed in the deployment region and the analysis of block 506, the deployment servers 160 may be able to identify one or more gaps in the network coverage.

If at block 508 it is determined that no gaps exist in the network coverage, then the method 500 may return to block 502 to continue monitoring and/or receiving location and/or status information from the deployed AP modules 120. If, however, at block 508 it is determined that there is at least one gap in network coverage within the deployment region, then at block 510, deployment of one or more additional AP modules may be initiated to provide coverage within the one or more identified gaps. In some cases, the deployment servers 160 may be communicate directly with deployment vehicles 180 to deploy additional AP modules 190. In other cases, the deployment servers 160 may communicate with an intermediary element, such as a remote sever that may control the use and schedule the sorties of deployment vehicles 180. In the same or other cases, the deployment servers 160 may, individually or in cooperation with other entities, be configured to generate a queue of AP modules 190 to be delivered. This queue may be generated, in certain example embodiments, based on the priority of deployment. For example, the deployment servers 160 may place a relatively higher priority in filling coverage gaps 154 in locations that may have a relatively high population density, which may be determined form population maps, compared to other locations where gaps 154 may be identified.

It should be noted, that the method 500 may be modified in various ways in accordance with certain embodiments of the disclosure. For example, one or more operations of method 400 may be eliminated or executed out of order in other embodiments of the disclosure. Additionally, other operations may be added to method 500 in accordance with other embodiments of the disclosure.

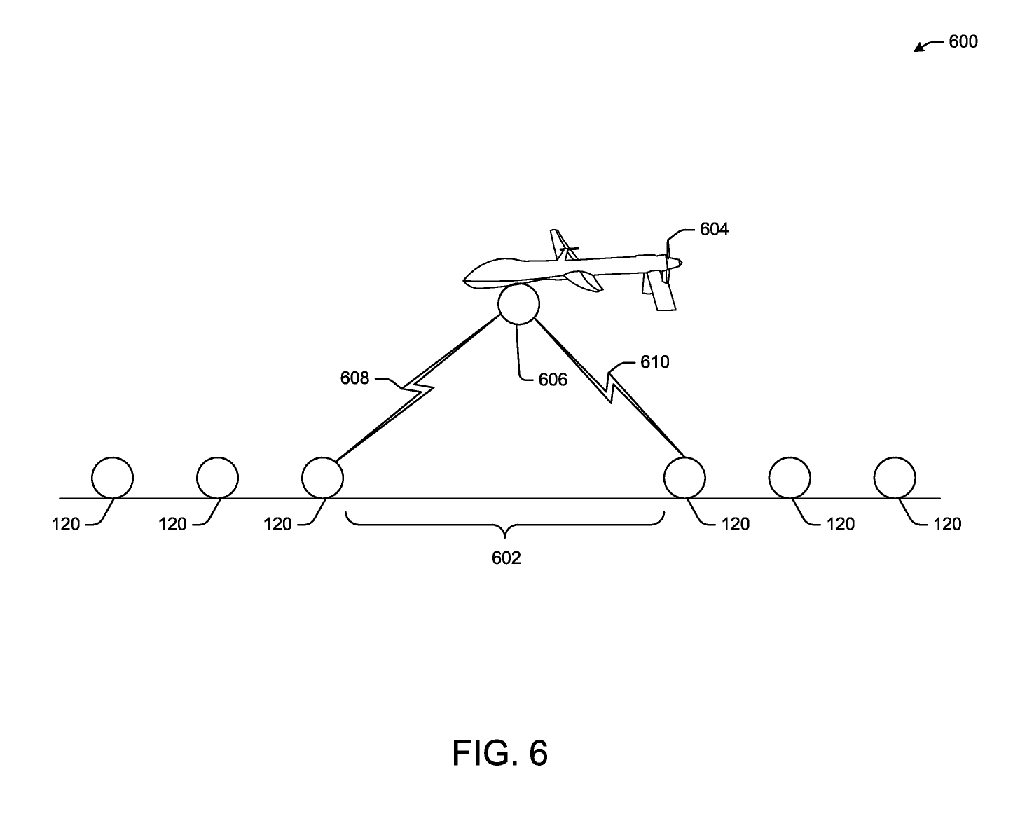

FIG. 6 is a schematic diagram illustrating an example environment where a network coverage gap 602 is filled by deployment of an AP module 606, in accordance with certain example embodiments of the disclosure. The coverage gap 602 may be determined to exist by the deployment servers 160, based at least in part on location information provided to the deployment servers 160 by the deployed AP modules 120 via the mesh network. Furthermore, the deployment servers 160 may consider one or more maps and/or geographic information about the deployment region 110 to determine the location of the gap 602 within the network coverage of the mesh network. Further still, the deployment servers 160 may consider the range of network coverage of each of the AP modules 120 in determining the location of coverage gaps of the mesh network.

After the determination of the location of the gap 602 within the mesh network, the deployment server 160 may initiate the launch of a vehicle 604, depicted herein as an aircraft, to deliver an additional AP module 606. As depicted here, the AP module 606 may remain on the vehicle 604 within the gap region 602 in some embodiments. By doing so, the additional AP module 606 may bridge the gap 602, or otherwise provide connectivity 608, 610 within the gap region 602 of the mesh network. In other embodiments, the vehicle 604 may deploy the additional AP module 606 within the gap region 602, such as by air dropping the additional AP module 602.

Embodiments described herein may be implemented using hardware, software, and/or firmware, for example, to perform the methods and/or operations described herein. Certain embodiments described herein may be provided as one or more tangible machine-readable media storing machine-executable instructions that, if executed by a machine, cause the machine to perform the methods and/or operations described herein. The tangible machine-readable media may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Example embodiments of the disclosure may include a method that may include receiving, by a deployment server comprising one or more processors, a plurality of location information, wherein each location information is associated with a respective corresponding access point (AP) module deployed in a deployment region. The method may further include determining, by the deployment server and based at least in part on the plurality of location information, if a network coverage gap exists in the deployment region and, if a network coverage gap exists, initiating, by the deployment servers, the deployment of an additional AP module to a location within the network coverage gap.

Further embodiments may include the method, wherein the location information associated with the respective corresponding AP modules comprise a latitude and longitude value. Yet further, the method may include determining that the network coverage exists comprises identifying, by the deployment server, at least one map associated the deployment region. In certain example embodiments, the at least one map associated with the deployment region comprises at least one of: (i) physical maps; (ii) political maps; (iii) road maps; (iv) resource maps; (v) climate maps; (vi) topography maps; or (vii) population maps. In yet other example embodiments, the method may include that identifying the at least one map associated with the deployment region comprises retrieving, by the deployment server from one or more networks, the at least one map. Further still, initiating deployment of the additional AP module comprises communicating a set of deployment instructions to a deployment vehicle. Example methods may further include receiving network traffic from at least one of the AP modules deployed in the deployment region.

In example embodiments of the disclosure, there may be one or more computer-readable media comprising computer-executable instructions that, when executed by one or more processors, configure the one or more processors to receive a plurality of location information, wherein each location information is associated with a respective corresponding access point (AP) module deployed in a deployment region, determine, based at least in part on the plurality of location information, if a network coverage gap exists in the deployment region, and if a network coverage gap exists, then initiate the deployment of an additional AP module in the network coverage gap.

In certain example embodiments, configuring the one or more processors to determine that a network coverage gap exists is based at least in part on at least one map associated the deployment region. In further example embodiments, the at least one map associated with the deployment region comprises at least one of: (i) physical maps; (ii) political maps; (iii) road maps; (iv) resource maps; (v) climate maps; (vi) topography maps; or (vii) population maps. Further still, the one or more processors to determine that a network coverage gap exists comprises configuring the one or more processors to generate a network coverage map based at least in part on the at least one map and the plurality of location information.

In certain further example embodiments, the computer-executable instructions, when executed by the one or more processors, further configure the one or more processors to receive a plurality of status information, each of the plurality of status information corresponding to each of the respective corresponding AP modules, predict, based at least in part on the plurality of status information, that one of the AP modules is going to fail, and initiate the deployment of a second additional AP module based at least in part on the location information corresponding to the AP module that is predicted to fail. In further example embodiments, the computer-executable instructions, when executed by one or more processors, further configure the one or more processors to transmit the location information corresponding to the AP module that is predicted to fail to an AP module delivery vehicle.

In example embodiments of the disclosure, there may be an access point (AP) module, comprising a first antenna communicatively coupled to a radio and configured to receive and transmit radio frequency (RF) communications, a second antenna configured to receive global navigation satellite system (GNSS) signals, and one or more processors configured to receive a beacon signal from the radio and based, at least in part on the beacon signal, communicatively connect the AP module to a mesh network, wherein the one or more processors are further configured to determine a location information based at least in part on the GNSS signals and transmit the location information via the mesh network.

In further example embodiments, the beacon signal comprises a mesh network identifier. In still further example embodiments, the mesh network identifier is a service set identifier (SSID). In yet further example embodiments, the one or more processors configured to communicatively connect the AP module to the mesh network comprises the one or more processors configured to identify a second AP module identified as a nearest neighbor within the mesh network. In example embodiments, the location information comprises at least one of: (i) latitude of the AP module; (ii) longitude of the AP module; or (iii) altitude of the AP module.

In some example embodiments, the AP module further comprises at least one sensor configured to provide status signals, wherein the one or more processors are configured to generate status information based at least in part on the status signals and transmit the status information, or an indication thereof, via the mesh network. In example embodiments, the status information comprises at least one of: (i) a transmit/receive signal strength; (ii) an effective transmit/receive bandwidth; (iii) a power level of the AP module; (iv) a battery charge level of the AP module; or (v) a supplementary power generation level.

Example embodiments of the disclosure may further include a method, comprising receiving, by an access point (AP) module comprising one or more processors, a beacon signal associated with a mesh network, connecting, by the AP module and based at least in part on the received beacon signal, to the mesh network, identifying, by the AP module, a location information associated with the AP module, and transmitting, by the AP module to a deployment server, the location information associated with the AP module.

In further example embodiments, connecting to the mesh network comprises identifying, by the AP module, a mesh network identifier based at least in part on the received beacon signal. In yet further example embodiments, the mesh network identifier is a service set identifier (SSID). In still further example embodiments, connecting to the mesh network comprises identifying, by the AP module, a second AP module identified as a nearest neighbor within the mesh network. In some example embodiments, the location information comprises at least one of: (i) latitude of the AP module; (ii) longitude of the AP module; or (iii) altitude of the AP module. Additional example embodiments may further include generating, by the AP module, status information based at least in part on the status signals and transmit the status information, or an indication thereof, via the mesh network. In some example embodiments, the status information comprises at least one of: (i) a transmit/receive signal strength; (ii) an effective transmit/receive bandwidth; (iii) a power level of the AP module; (iv) a battery charge level of the AP module; or (v) a supplementary power generation level.

Example embodiments may further include an apparatus for providing communications services, comprising means for receiving a beacon signal associated with a mesh network, means for connecting, based at least in part on the received beacon signal, to the mesh network, means for identifying a location information associated with the AP module, and means for transmitting, to a deployment server, the location information associated with the AP module

In further example embodiments the apparatus may be such that the means for connecting to the mesh network comprises a means for identifying a mesh network identifier based at least in part on the received beacon signal. The apparatus may include a means for moving based at least in part on a signal strength of the received beacon signal and one or more heuristics. In yet further embodiments, the means for connecting to the mesh network comprises a means for identifying, by the AP module, a second AP module identified as a nearest neighbor within the mesh network. In still further example embodiments, the location information comprises at least one of: (i) latitude of the AP module; (ii) longitude of the AP module; or (iii) altitude of the AP module. In some example embodiments, the apparatus may further include a means for generating status information based at least in part on the status signals and transmit the status information via the mesh network. In other example embodiments the status information comprises at least one of: (i) a transmit/receive signal strength; (ii) an effective transmit/receive bandwidth; (iii) a power level of the AP module; (iv) a battery charge level of the AP module; or (v) a supplementary power generation level.

Example embodiments may include one or more computer-readable media storing computer-executable instructions that, when executed by at least one processor, configure the at least one processor to perform operations comprising receiving a beacon signal associated with a mesh network, connecting, based at least in part on the received beacon signal, to the mesh network, identifying a location information associated with the AP module, and transmitting, to a deployment server, the location information associated with the AP module.

Example embodiments may further include the one or more computer-readable media, wherein connecting to the mesh network comprises identifying a mesh network identifier based at least in part on the received beacon signal. In further example embodiments, the one or more computer-readable media, wherein the at the least one processor is to further perform operations comprising moving based at least in part on a signal strength of the received beacon signal and one or more heuristics. In still further example embodiments, the one or more computer-readable media of, wherein connecting to the mesh network comprises identifying a second AP module identified as a nearest neighbor within the mesh network. In an example embodiment, the one or more computer-readable media, wherein the location information comprises at least one of: (i) latitude of the AP module; (ii) longitude of the AP module; or (iii) altitude of the AP module. In further example embodiments, the one or more computer-readable media, wherein the at the least one processor is to further perform operations comprising generating status information based at least in part on the status signals and transmit the status information via the mesh network. In still further example embodiments, the one or more computer-readable media, wherein the status information comprises at least one of (i) a transmit/receive signal strength; (ii) an effective transmit/receive bandwidth; (iii) a power level of the AP module; (iv) a battery charge level of the AP module; or (v) a supplementary power generation level.

The claimed invention is:

1. A method, comprising:
receiving, by a deployment server comprising one or more processors, a plurality of location information, wherein each location information is associated with a respective corresponding access point (AP) module deployed in a deployment region;
determining, by the deployment server and based at least in part on the plurality of location information, whether a network coverage gap exists in the deployment region; and
if a network coverage gap exists, initiating, by the deployment servers, the deployment of an additional AP module to a location within the network coverage gap.

2. The method of claim 1, wherein the location information associated with the respective corresponding AP modules comprise a latitude and longitude value.

3. The method of claim 1, wherein determining that the network coverage exists comprises identifying, by the deployment server, at least one map associated the deployment region.

4. The method of claim 3, wherein the at least one map associated with the deployment region comprises at least one of: (i) physical maps; (ii) political maps; (iii) road maps; (iv) resource maps; (v) climate maps; (vi) topography maps; or (vii) population maps.

5. The method of claim 3, wherein identifying the at least one map associated with the deployment region comprises retrieving, by the deployment server from one or more networks, the at least one map.

6. The method of claim 1, wherein initiating deployment of the additional AP module comprises communicating a set of deployment instructions to a deployment vehicle.

7. The method of claim 1, further comprising initiating, by the deployment servers, batch transfer of data in the location within the network coverage gap via a deployment vehicle comprising one or more data stores.

8. One or more computer-readable media comprising computer-executable instructions that, when executed by one or more processors, configure the one or more processors to:
receive a plurality of location information, wherein each location information is associated with a respective corresponding access point (AP) module deployed in a deployment region;
determine, based at least in part on the plurality of location information, whether a network coverage gap exists in the deployment region; and
if a network coverage gap exists, initiate the deployment of an additional AP module in the network coverage gap.

9. The one or more computer-readable media of claim 8, wherein configuring the one or more processors to determine whether a network coverage gap exists is based at least in part on at least one map associated the deployment region.

10. The one or more computer-readable media of claim 9, wherein the at least one map associated with the deployment region comprises at least one of: (i) physical maps; (ii) political maps; (iii) road maps; (iv) resource maps; (v) climate maps; (vi) topography maps; or (vii) population maps.

11. The one or more computer-readable media of claim 9, wherein configuring the one or more processors to determine whether a network coverage gap exists comprises configuring the one or more processors to generate a network coverage map based at least in part on the at least one map and the plurality of location information.

12. The one or more computer-readable media of claim 8, wherein the computer-executable instructions, when executed by the one or more processors, further configure the one or more processors to:
receive a plurality of status information, each of the plurality of status information corresponding to each of the respective corresponding AP modules;
predict, based at least in part on the plurality of status information, that one of the AP modules is going to fail; and
initiate the deployment of a second additional AP module based at least in part on the location information corresponding to the AP module that is predicted to fail.

13. The one or more computer-readable media of claim 12, wherein the computer-executable instructions, when executed by the one or more processors, further configure the one or more processors to transmit the location information corresponding to the AP module that is predicted to fail to an AP module delivery vehicle.

14. An access point (AP) module, comprising:
a first antenna communicatively coupled to a radio and configured to receive and transmit radio frequency (RF) communications;
a second antenna configured to receive global navigation satellite system (GNSS) signals; and
one or more processors configured to receive a beacon signal through the radio and based, at least in part on the beacon signal, to communicatively connect the AP module to a mesh network, wherein the one or more processors are further configured to determine a location information of the AP module based at least in part on the GNSS signals and to transmit the location information via the mesh network.

15. The AP module of claim 14, wherein the beacon signal comprises a mesh network identifier.

16. The AP module of claim 14, wherein the one or more processors configured to communicatively connect the AP module to the mesh network comprises the one or more processors configured to identify a second AP module identified as a nearest neighbor within the mesh network.

17. The AP module of claim 14, further comprising at least one sensor configured to provide status signals, wherein the one or more processors are configured to generate status information based at least in part on the status signals and transmit the status information via the mesh network.

18. The AP module of claim 17, wherein the status information comprises at least one of: (i) a transmit/receive signal strength; (ii) an effective transmit/receive bandwidth; (iii) a power level of the AP module; (iv) a battery charge level of the AP module; or (v) a supplementary power generation level.

19. A method, comprising:
receiving, by an access point (AP) module comprising one or more processors, a beacon signal associated with a mesh network;
connecting, by the AP module and based at least in part on the received beacon signal, to the mesh network;
identifying, by the AP module, a location information associated with the AP module; and
transmitting, by the AP module, the location information associated with the AP module.

20. The method of claim 19, wherein connecting to the mesh network comprises identifying, by the AP module, a mesh network identifier based at least in part on the received beacon signal.

21. The method of claim 20, further comprising moving, by the AP module, based at least in part on a signal strength of the received beacon signal and one or more heuristics.

22. The method of claim 19, wherein connecting to the mesh network comprises identifying, by the AP module, a second AP module identified as a nearest neighbor within the mesh network.

23. The method of claim 19, further comprising generating, by the AP module, status information based at least in part on the status signals and transmit the status information via the mesh network.

24. The method of claim 23, wherein the status information comprises at least one of: (i) a transmit/receive signal strength; (ii) an effective transmit/receive bandwidth; (iii) a power level of the AP module; (iv) a battery charge level of the AP module; or (v) a supplementary power generation level.
